(19) United States
(12) Patent Application Publication
(10) Pub. No.: US 2017/0356215 A1
(43) Pub. Date: Dec. 14, 2017

(54) JUMP SUICIDE PREVENTION DEVICE FOR BRIDGE RAILINGS

(71) Applicant: Hui Seop KIM, Incheon (KR)

(72) Inventor: Hui Seop KIM, Incheon (KR)

(21) Appl. No.: 15/311,230

(22) PCT Filed: Jun. 5, 2015
(86) PCT No.: PCT/KR2015/005639

§ 371 Date: Nov. 15, 2016

(30) Foreign Application Priority Data
Feb. 25, 2015 (KR) 10-2015-0026759

(51) Int. Cl. E04H 17/00; F21V 33/00; E01D 19/10; F21V 3/02

(52) U.S. Cl. CPC E04H 17/003; F21V 3/02; F21V 33/0064; E01D 19/10

(57) ABSTRACT

A jump suicide prevention device includes a pair of link parts disposed to face each other in a longitudinal direction of the bridge railing, a roller part including rotation parts on opposite sides thereof in the longitudinal direction to be rotatably coupled between the link parts, leg parts respectively coupled to lower ends of the link parts by fastening members, and resilient members installed between end portions of the link part and the leg part with being interposed therebetween to control vertical movements of the link part. As a jump suicide prevention device capable of preventing a suicide jumper from jumping over the upper portion of the bridge railing, the device may prevent incidents of jump suicide from bridge railings due to the configuration of the roller part which rotates while vertically pivoting according to the weight of the suicide jumper.

### TECHNICAL FIELD

The present invention relates to a jump suicide prevention device for bridge railings, and more particularly, to a jump suicide prevention device for bridge railings which may effectively prevent an occurrence of an incident of jump suicide using the bridge railings by physically preventing a suicide jumper from jumping over upper portions of the bridge railings installed on a bridge by means of link parts installed on the bridge railings, and a roller part installed to be vertically pivoted at upper portions of the link parts and leg parts.

### BACKGROUND ART

Bridges are a structure that is installed to solve such a problem occurring in a case that a function of a moving passage is hindered by environmental factors such as a river, sea level, or a lake surface, etc.

Such a bridge is installed with being apart from the ground or sea so as to have a large difference in a height therebetween depending on characteristics of a location in which the bridge is installed. According to the characteristics of such the bridge, an incident of jump suicide frequently occurs at an upper portion of the installed bridge. Cases of the jump suicide actually occurring and resulting in loss of life are gradually increasing.

Conventionally, it has been attempted to prevent the incidents of jump suicides that may occur on the bridge by installing bridge railings on an upper portion of the installed bridge. However, the conventional bridge railings installed on the bridge have a problem that the suicide jumper may easily jump over the bridge railings, such that it is difficult to prevent the incidents of jump suicides.

In addition, there are many plans executed as a countermeasure for prevention of the incidents of jump suicides by installing structures, or stickers, etc., on which anti-jump suicide phrases or marks are drawn, or various means able to stabilize the mental state of the suicide jumper around the bridge, thus to prevent the incidents of jump suicides. However, it is difficult to effectively prevent incidents of jump suicides on the bridges.

Accordingly, there have been proposed plans such as Patent Document 1 and Patent Document 2 capable of physically preventing incidents of jump suicides on the bridges. However, the conventional jump suicide prevention device disclosed in Patent Document 1 has a problem that, when installing the device on the bridge railings, it is difficult to smoothly install the same along a longitudinal direction of the bridge. In addition, if the rotatably installed rotation bar droops or becomes separated after installation of the device, there is a problem that it is difficult to achieve the original function of the device of preventing the incidents of jump suicides. Further, when the suicide jumper tries to climb up and jump over the upper portion of fences installed on the bridge, it is difficult to achieve the original function of preventing the incidents of jump suicides due to the rotation bar having a configuration capable of rotating also in an outer direction of the bridge.

In addition, the conventional jump suicide prevention device disclosed in Patent Document 2 includes rolling parts provided on the bridge railings so as to prevent a person who intends to make a jump suicide from climbing up the bridge railing, such that the suicide jumper climbing up the bridge railing is prevented by the rotation of the rolling parts. However, the conventional jump suicide prevention device such as Patent Document 2 may be specialized and applied only to bridges to which arched structures are applied. In particular, the device is only effective for preventing suicide attempts and for disturbance of the suicide jumper which has climbed on the arched structure, but it is difficult to prevent the accident of the suicide jumper who intends to actually jump over the bridge railings.

### PRIOR ART DOCUMENT

### Patent Document

[Patent Document 1] Korean Patent Registration No. 10-1490116 (2015 Jan. 30)

[Patent Document 2] Korean Utility Model Registration No. 20-0274845 (2002 Apr. 29)

### DISCLOSURE

### Technical Problem

In order to solve the above-mentioned problems, it is an object of the present invention to provide a jump suicide prevention device for bridge railings which is a device installed at a location for preventing incidents of jump suicides from bridges so as to prevent the incidents of jump suicides on the bridges, and may effectively prevent the incidents of jump suicides using the bridge railings by means of a configuration including link parts installed on the bridge railings, a roller part rotatably connected to the link parts, and leg parts coupled to the link parts so as to control a vertical pivoting of the roller part.

In addition, another object of the present invention is to provide a jump suicide prevention device for bridge railings which is configured to prevent a suicide jumper who tries to jump over upper portions of the bridge railings from moving using his or her body by griping leg parts or link parts with hands, and cause the suicide jumper who tries to jump over the upper portion of the bridge railings to fall inside of the bridge railings by flexing in correspondence to a weight of the suicide jumper, such that it is possible to easily perform a maintenance work after installation, maximally reduce a danger of damage, stably and efficiently prevent the incidents of jump suicides, and obtain effects of reducing entire costs for preventing the incidents of jump suicides.

### Technical Solution

In order to accomplish the above objects, there is provided a jump suicide prevention device for bridge railings, including: a pair of link parts disposed so as to face each other on a bridge railing in a longitudinal direction thereof; a roller part which includes rotation parts on opposite sides thereof in the longitudinal direction so as to be rotatably coupled between the link parts in one direction; leg parts which are respectively coupled to lower ends of the link part by fastening members P, and elastic members which are installed between end portions of the link part and the leg part with being interposed therebetween to control vertical pivoting of the link part.

Herein, the link part may include: a coupling hole 1 formed in a bar shape at one end thereof in the longitudinal direction; and a fastening hole formed at the other end thereof facing the coupling hole 1 in the longitudinal direction so as to allow the fastening member to be inserted.

Further, the roller part may include: a shaft rod installed so as to connect the link parts with each other, while the rotation parts are coupled to the opposite ends thereof; and a roller body which is arranged so as to surround an outer circumference of the shaft rod, and is rotatably coupled to the shaft rod in one direction through the rotation part at an outside thereof.

Further, the roller body may be formed in a circular bar shape having a through hole into which the shaft rod is inserted.

In addition, the rotation part may be configured to be coupled inside the through hole of the roller body.

Further, the roller body may be formed in a circular sphere shape having a through hole into which the shaft rod is inserted, and a plurality of roller bodies may be connected with each other in the longitudinal direction of the shaft rod.

Further, the rotation part may include a fixed body which is fixed to the outer circumference of the shaft rod; and a rotating body coupled so as to surround an outer circumference of the fixed body, wherein a latch portion and needle rollers may be provided at a coupled portion between the fixed body and the rotating body, which are configured to allow the rotating body to rotate in one direction about the fixed body.

Meanwhile, the shaft rod may include a protrusion formed on one side of the outer circumference thereof; and a fixing hole to which one end of the fastening member passing through the leg part and the link part is fastened and fixed, and the fixed body may include a fitting groove to which the protrusion is fitted; and a through hole through which the fastening member passes to be coupled thereto.

Further, the shaft rod may include an insertion portion protruding in a circular protrusion shape at opposite ends in the longitudinal direction thereof, and the fixed body may include an insertion groove formed at one side of the through hole so as to allow the insertion portion be inserted therein.

Furthermore, the elastic member may include a spring having a first seat terminal and a second seat terminal which are formed in a bar shape at opposite ends thereof in the longitudinal direction.

In addition, the link part may include a first seat groove formed at a portion thereof to be seated at and coupled to one side of the elastic member; and a second seat groove that elongates from one side of the first seat groove to be engaged with the first seat terminal provided at one end of the elastic member.

Further, the leg part may include a first insert groove formed at a portion thereof to be seated at and coupled to the other side of the elastic member coupled to the link part, and a second insert groove that elongates from one side of the first insert groove to be engaged with the second seat terminal provided at the other end of the elastic member.

In addition, the leg part further may include a seat portion formed therein configured to firmly support the coupled link part when one side of the link part is coupled therewith, and control the pivoting of the link part.

Further, the first insert groove may be provided with an insertion hole into which the fastening member to be fastened to the fixing hole of the shaft rod is inserted.

Further, the roller part may be formed to have a thickness enough to prevent a suicide jumper who tries to jump suicide by jumping over the bridge railings from gripping the same.

Further, the roller part may rotate only in an inner direction of the bridges to be installed.

Furthermore, the link part and the leg part installed on the bridge railing may be arranged at an interval so as to prevent a suicide jumper who tries to jump suicide by jumping over the bridge railings from gripping outsides of the link part and the leg part by hands.

In addition, the leg part further may include a detection sensor provided on one side thereof, and the detection sensor is connected with a central control unit that receives a signal from the detection sensor through a wire and controls the device.

Further, the roller body may include a plurality of lamps, which are illuminated through a power source supplied from an outside, provided inside the through hole thereof, and the roller body is made of a material that allows light of the lamps to be transmitted therethrough.

### Advantageous Effects

The present invention as described above may achieve the following effects.

First, by the jump suicide prevention device capable of preventing the suicide jumper from jumping over the upper portion of the bridge railing, it is possible to prevent the incidents of jump suicides using the bridge railings by effectively controlling the movement of the suicide jumper who tries to jump over the upper portion of the roller part by using the configuration of the roller part which rotates while vertically pivoting in correspondence with the body weight of the suicide jumper.

Second, even when a plurality of devices are installed and used on the upper portions of the railings installed on the bridge, it is possible to effectively prevent a user from jumping over the upper portion of the roller part by gripping the installed link parts and the leg parts, thus to stably and efficiently prevent the incidents of jump suicides using the bridge railings.

Third, even when the suicide jumper tries to jump over the upper portion of the installed roller part, by using the configuration of the roller part which rotates while vertically pivoting in correspondence with the body weight of the suicide jumper, it is possible to cause the suicide jumper to fall inside of the bridge railings. Thereby, even if the engagement of the link part and the leg part or the rotating structure of the roller part is damaged during using after installation, it is possible to prevent the incidents of jump suicides of the suicide jumper only by the rotation of the roller part or the vertical pivoting of the roller part which is not damaged, thus to efficiently prevent the incidents of jump suicides which may occur by failure of the device.

Fourth, when installing and using the configuration including the link part, roller part, rotation part, leg part, and elastic member which are formed to be assembled and disassembled between the bridge railings, it is possible to easily assemble and use, and even if any one of the link part, roller part, rotation part, leg part, and elastic member is damaged, it is possible to easily replace the damaged part by a new part and use with increased convenience for using, and obtain effects of reducing production costs.

Fifth, since the roller rotatably installed on the upper portion of the bridge railing is configured to rotate in an inner direction of the bridge railing but to be prevented from rotating in an outer direction of the bridge railing, it is possible to prevent the suicide jumper who tries to jump suicide from falling outside the bridge railing to achieve stable use, and effectively prevent the suicide jumper from jumping over the upper portion of the roller part.

### DESCRIPTION OF DRAWINGS

FIG. 1 is an exploded perspective view illustrating a jump suicide prevention device for bridge railings of the present invention.

FIG. 2 is an assembled perspective view illustrating the jump suicide prevention device for bridge railings of the present invention.

FIG. 3 is a perspective view illustrating a state in which the jump suicide prevention device for bridge railings according to the present invention is installed and used on a bridge rail.

FIG. 4 is an exploded perspective view illustrating by extracting and enlarging major parts of the jump suicide prevention device for bridge railings according to the present invention.

FIG. 5 is an enlarged view illustrating by extracting major parts of a rotation part of the jump suicide prevention device for bridge railings according to the present invention.

FIG. 6 is an enlarged cross-sectional view illustrating by extracting the assembled major parts of the jump suicide prevention device for bridge railings according to the present invention.

FIG. 7 is a view illustrating an operation state in which a link part pivotally coupled to a leg part is vertically pivoted through an elastic member according to the present invention.

FIG. 8 is an exploded perspective view illustrating a jump suicide prevention device for bridge railings according to another embodiment of the present invention.

FIG. 9 is a perspective view illustrating a state in which the jump suicide prevention device for bridge railings according to another embodiment of the present invention is installed and used on the bridge rail.

FIG. 10 is a perspective view illustrating by extracting major parts of a state in which a detection sensor is attached to one side of a leg part according to another embodiment of the present invention.

FIG. 11 is a perspective view illustrating by extracting major parts of a state in which lamps are provided inside of a roller part according to another embodiment of the present invention.

### BEST MODE

Hereinafter, the present invention will be described in detail with reference to the accompanying drawings.

Prior to description, preferably embodiments of the present invention will be described in detail with reference to the accompanying drawings. First, in denoting reference numerals to constitutional elements of respective drawings, it should be noted that the same elements will be denoted by the same reference numerals although they are illustrated in different drawings. Furthermore, the terms as used herein are defined by taking functions of the present disclosure into account and can be changed according to the custom or intention of users or operators. Therefore, definition of the terms should be made according to the overall disclosure set forth herein.

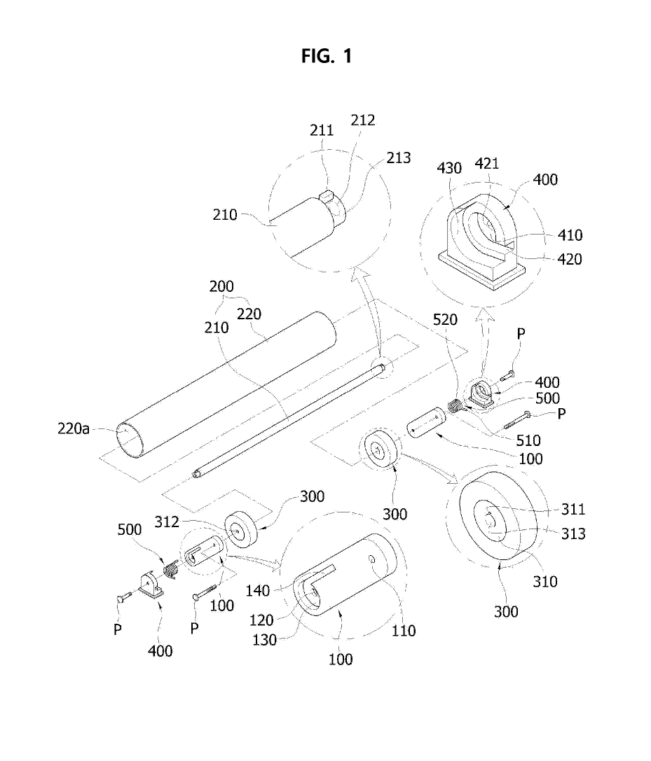

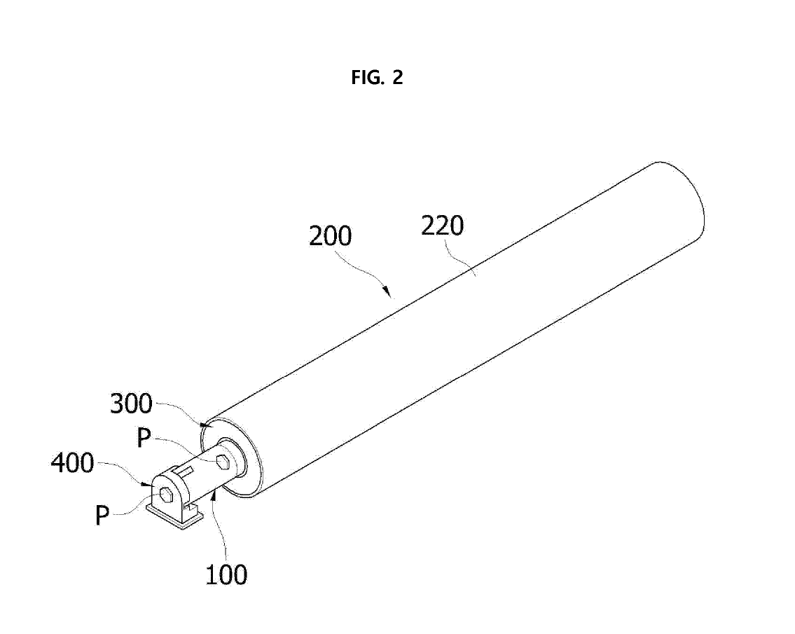

First, configurations illustrated in FIGS. 1 to 9 will be described.

A jump suicide prevention device of the present invention includes: a pair of link parts 100 disposed so as to face each other on an upper portion of a bridge railing 10; a roller part 200 installed inside of the link parts 100 in a longitudinal direction and having rotation parts 300 on opposite sides thereof; leg parts 400 coupled to lower ends of the link parts 100 by fastening members P; and elastic members 500 installed between the ends of the link parts 100 and the leg parts 400 with being interposed therebetween.

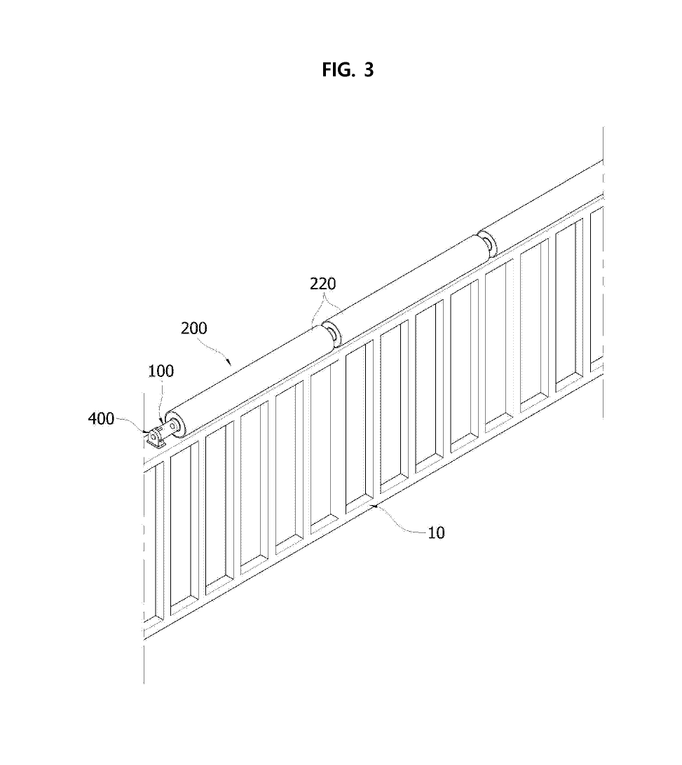

As illustrated in FIG. 3, the link parts 100 are installed to face each other in the longitudinal direction on an upper portion of the bridge railing 10 to which the jump suicide prevention device of the present invention is installed. It is preferable that the link parts are made of a material such as a metal material so as to maintain a firmly coupled state even when the roller part 200 and the rotation parts 300 coupled to the link parts 100 are pivoted.

That is, the link parts 100 are coupled with the leg parts 400 installed on the upper portion of the bridge railing 10, such that it is possible to firmly maintain the position installed on the upper portion of the bridge railing 10, as illustrated in FIG. 3.

In addition, as illustrated in FIGS. 1 to 5, the link part 100 is formed so as to have a bar shape, and includes a coupling hole 110 formed at one end thereof in the longitudinal direction, and a fastening hole 120 formed at the other end thereof facing the coupling hole 110 in the longitudinal direction.

The coupling hole 110 is configured to allow the roller part 200 and the rotation part 300 to be firmly coupled to one side of the link part 100 by using the fastening member P. As illustrated in FIG. 1, the fastening member P inserted into the coupling hole 110 passes through the rotation part 300 and is fastened to the roller part 200, so that the roller part 200 and the rotation part 300 can be located between the link parts 100 which are installed at an interval on the upper portion of the bridge railing 10.

In addition, the fastening hole 120 is configured to allow the leg part 400 to be coupled to one side of the link part 100 through the fastening member P. As illustrated in FIG. 1, the elastic member 500 is configured so that one side thereof is seated on one side of the fastening hole 120.

The roller part 200 is coupled to one side of the link part 100 through the fastening member P so as to be rotatably coupled in one direction.

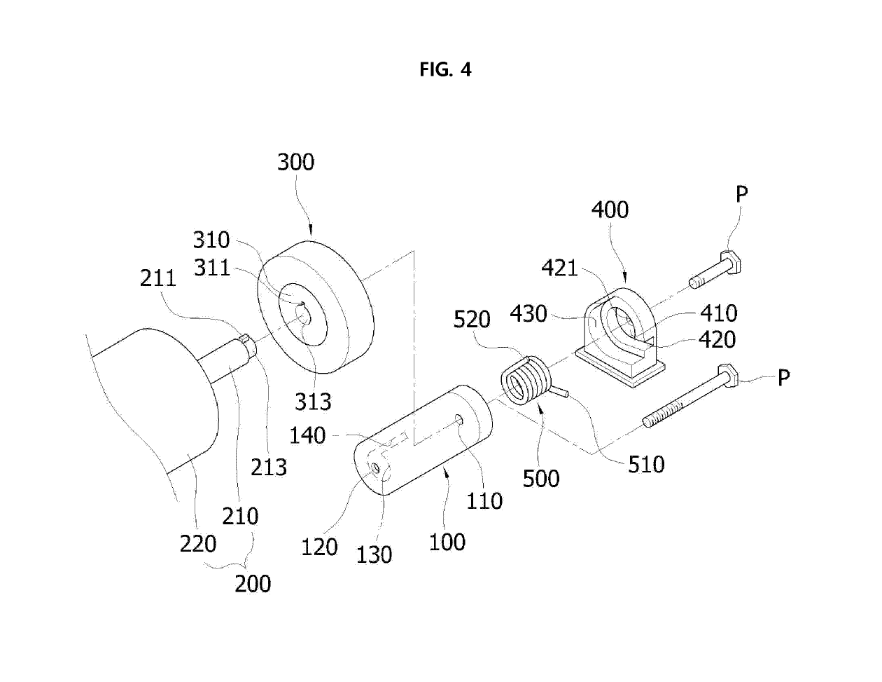

As illustrated in FIG. 4, the roller part 200 includes: a shaft rod 210 configured to connect the pair of link parts 100 installed so as to face each other, while the rotation parts 300 are coupled to the opposite ends thereof; and a roller body 220 which is arranged so as to surround the outer circumference of the shaft rod 210, and is rotatably coupled to the shaft rod 210 in one direction through the rotation part 300 at an outside thereof.

The shaft rod 210 is disposed so as to pass through the inside of the roller body 220, and is configured so that the opposite ends thereof are coupled to the rotation parts 300 installed inside of the roller body 220.

At this time, as illustrated in FIGS. 1 and 4, the shaft rod 210 includes a protrusion 211 formed on one side of the outer circumference thereof.

By such the configuration, when a fixed body 310 of the rotation part 300 is coupled to one side of the shaft rod 210, the protrusion 211 is inserted into a fitting groove 311 formed in the fixed body 310 to be fitted thereto, such that the rotation part 300 coupled to opposite ends of the shaft rod 210 may be maintained with being firmly coupled to the opposite ends of the shaft rod 210.

In addition, the shaft rod 210 includes insertion portions 213 formed on the opposite ends in the longitudinal direction thereof by protruding in a circular protrusion shape as illustrated in FIGS. 1 and 4, such that, in a case of coupling with the fixed body 310 of the rotation part 300, the insertion portion 213 of the shaft rod 210 is inserted into the insertion groove 313 formed in the fixed body 310. Therefore, the rotation part 300 may be maintained with being more firmly coupled to the opposite ends of the shaft rod 210.

In addition, as illustrated in FIG. 1, the roller body 220 includes a through hole 220a formed therein in the longitudinal direction so as to allow the shaft rod 210 to be inserted. In the present invention, the roller body 220 is illustrated and described so as to be formed in a circular bar, it is not limited thereto, but the shape and configuration of the roller body 220 may be variously changed and applied so long as the shaft rod 210 can be smoothly inserted into the roller body 220, while preventing the suicide jumper who tries to jump suicide using the bridge railing 10 from easily griping the outer circumference of the roller body 220.

In the configuration of coupling the shaft rod 210 and the roller body 220 with each other, even when the roller body 220 is configured so as to rotate in one direction through the configuration of the rotation part 300 which is coupled therein, it is preferable that the shaft rod 210 is configured to not rotate in correspondence with the rotation of the roller body 220. When the bridge railings 10 are installed on the sea level, in order to prevent the device from being corroded even if being maintained in the installed state for a long period time due to an influence of sea water and used appropriately, it is more preferable that the parts of the inventive device are made of a metal material such as stainless steel, iron, copper, or aluminum in consideration of costs and installation conditions.

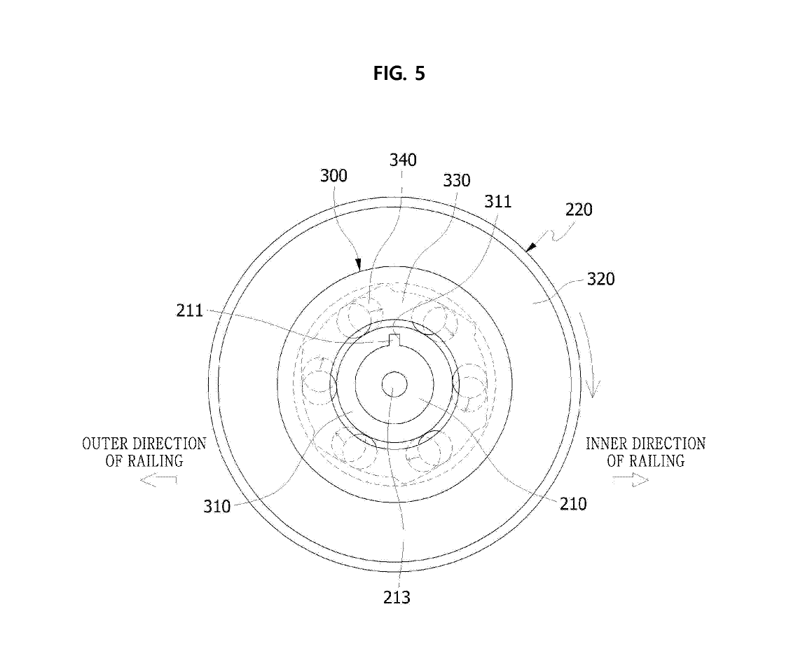

In addition, as illustrated in FIG. 5, the rotation parts 300 coupled to opposite sides of the roller part 200 are configured to be coupled to the opposite ends of the shaft rod 210 of the roller part 200, then be coupled inside the through hole 220a of the roller body 220.

In the above-described configuration, as illustrated in FIG. 5, since the shaft rod 210 coupled to the rotation part 300 is firmly coupled with the link part 100 through the fastening member P, an inner portion of the rotation part 300 coupled with the shaft rod 210 is firmly fixed to one side of the link part 100 to not rotate, while an outer portion of the rotation part 300 coupled inside the through hole 220a of the roller body 220 is configured to freely rotate. Therefore, as illustrated in FIG. 5, the roller body 220 can rotate smoothly about the shaft rod 210 installed therein.

For this, the rotation part 300 includes the fixed body 310 firmly coupled to the outer circumference of the shaft rod 210, a rotating body 320 coupled to the roller body so as to surround an outer circumference of the fixed body 310, and a latch portion 330 and needle roller 340s which are disposed at a coupled portion between the fixed body 310 and the rotating body 320, which are configured to allow the rotating body 320 to rotate in one direction about the fixed body 310.

The above-described configuration is configured so as to allow the rotating body 320 coupled inside the through hole 220a of the roller body 220 to rotate in one direction about the fixed body 310 coupled with the shaft rod 210. The configuration of the latch portion 330 and the needle rollers 340 for achieving such a configuration is the same as that of the conventional latch structure and needle rollers for allowing the rotating body 320 to rotate only one direction in terms of function and configuration, and therefore will not be described in detail.

In addition, as illustrated in FIGS. 1 and 5, the fixed body 310 includes the fitting groove 311 to which the projection 211 of the above-described shaft rod 210 is fitted, and a through hole 312 through which the fastening member P inserted into a fixing hole 212 of the shaft rod 210 can be coupled.

The above-described configuration is used to more firmly couple the shaft rod 210 and the fixed body 310 with each other. After the protrusion 211 of the shaft rod 210 is fitted to the fitting groove 311 of the fixed body 310, the fastening member P to be fixed to the fixing hole 212 passes through the through hole 312, and fastened to the coupling hole 110 of the link part 100 located at one side of the through hole 312. Thereby, an operator may adjust the fastening member P fastened to the coupling hole 110 to allow the fixed body 310 of the rotation part 300 to not rotate in correspondence with the rotation of the rotating body 320 coupled with the roller body 220, while the link part 100, the shaft rod 210 and the fixed body 310 are firmly coupled with each other.

Further, since the fixed body 310 includes the insertion groove 313 formed at one side of the through hole 312, to which the insertion portion 213 of the shaft rod 210 can be inserted, even when the fixed body 310 and the shaft rod 210 are coupled to one side of the link part 100 through the fastening member P, it is possible to prevent the fixed body 310 and the shaft rod 210 from being separated from the link part, thus to maintain more firm coupling therebetween.

At this time, in a case of the insertion portion 213 and the insertion groove 313, the shape of the insertion portion 213 and the insertion groove 313 and the coupling configuration therebetween may be variously changed according to a selection of a user, so long as they have a configuration that does not hinder the coupling of the fastening member P to be coupled to the fixing hole 212 and the through hole 312, while maintaining the state in which the insertion portion 213 is inserted into the insertion groove 313 to be firmly coupled thereto.

In addition, as illustrated in FIGS. 1 to 4, the leg part 400 is coupled with the lower end of the link part 100 through the fastening member P.

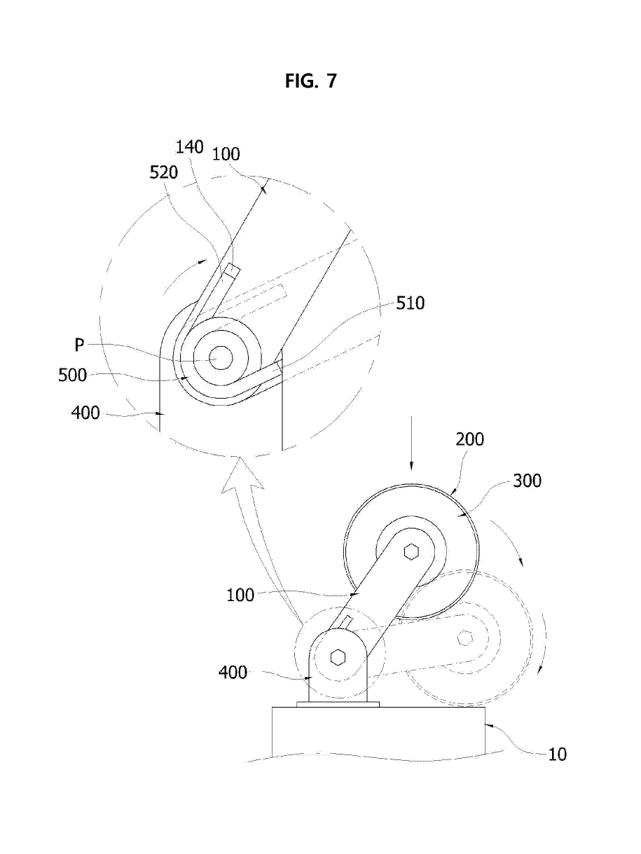

In particular, as described above, the leg part 400 is coupled to the link part 100 with the elastic member 500 interposed therebetween. As illustrated in FIG. 7, the link part 100 coupled to one side of the leg part 400 may be coupled to be vertically pivoted through the configuration of the elastic member 500.

In the above-described configuration, the elastic member 500 includes a spring, that is, includes a spring having a first seat terminal 510 and a second seat terminal 520 which are formed in a bar shape at opposite ends thereof in the longitudinal direction. By the above-described configuration, the first seat terminal 510 of the elastic member 500 is engaged to one side of the link part 100, and the second seat terminal 520 of the elastic member 500 is engaged to one side of the leg part 400. Therefore, the link part 100 coupled to the leg part 400 is configured to be able to be pivoted about the coupled portion with the elastic member 500.

Further, in order to maintain a state in which the elastic member 500 is smoothly coupled between the leg part 400 and the link part 100, the link part 100 includes a first seat groove 130 formed at a portion thereof closely contacting with one side of the elastic member 500 to be seated at and coupled to one side of the elastic member 500, and a second seat groove 140 that elongates from one side of the first seat groove 130 to be engaged with the first seat terminal 510 provided at one end of the elastic member 500, and the leg part 400 includes a first insert groove 410 formed at a portion thereof closely contacting with the other side of the elastic member 500 coupled to the link part 100 to be seated at and coupled to the other side of the elastic member 500, and a second insert groove 420 that elongates from one side of the first insert groove 410 to be engaged with the second seat terminal 520 provided at the other end of the elastic member 500.

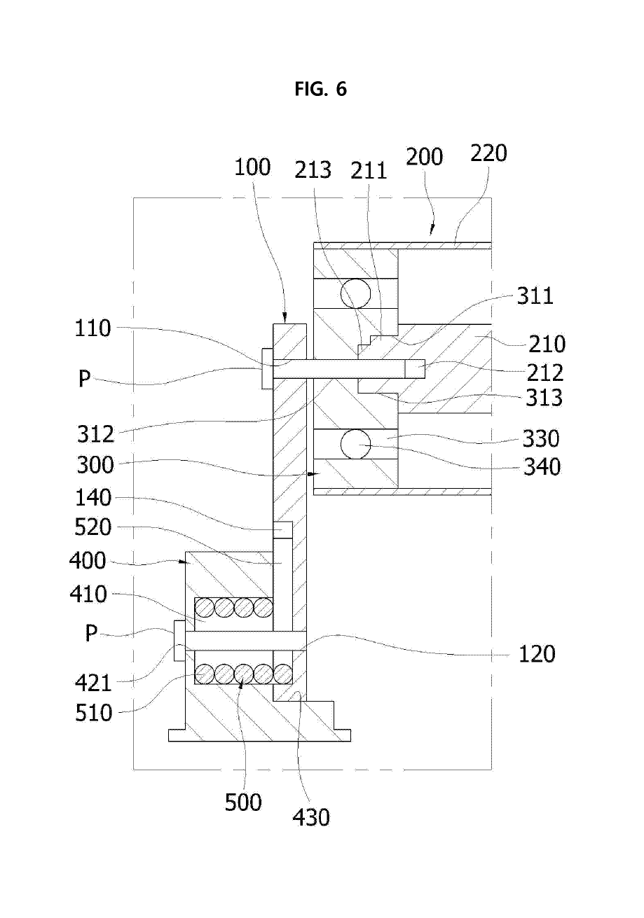

By the above-described configuration, when the elastic member 500 is coupled between the leg parts 400 and the link part 100, as illustrated in FIG. 6, the first seat terminal 510 of the elastic member 500 is engaged to the second seat groove 140 of the link part 100, while one side of the elastic member 500 is naturally seated to the first seat groove of the link part 100, and the second seat terminal 520 of the elastic member 500, which is located so as to be opposite thereto, is engaged to the second insert groove 420 of the leg part 400, while one side of the elastic member 500 is seated to the first insert groove of the leg part 400, such that the elastic member 500 may be maintained with being stably firmly between the leg parts 400 and the link part 100. By the configuration of the first seat terminal 510 and the second seat terminal 520, when the link part 100 engaged with the first seat terminal 510 is pivoted, as illustrated in FIG. 7, the link part 100 may be returned to an original position by the restoring force of the first seat terminal 510, using properties of the spring (elastic member) to be returned to an original state.

That is, after the leg part 400 and the link part 100 are coupled with each other with the elastic member 500 interposed therebetween, when a pressure due to the weight of a suicide jumper is applied to the upper portion of the roller part 200 coupled inside of the link part 100, as illustrated in FIG. 7, the roller part 200 is lowered and rotated to the inside of the bridge railing 10. Therefore, a direction of the pressure applied to the roller part 200 is changed due to the weight of the suicide jumper who tries to jump suicide, and thereby, according to the direction change of the pressure, the pressure of the suicide jumper that is applied to the upper portion of the roller part 200 is reduced, and the roller part 200 is returned to the original position by the restoring force of the elastic member 500 coupled between the leg part 400 and the link part 100.

Accordingly, the suicide jumper who tries to jump over the upper portion of the roller part 200 naturally moves in the inner direction of the bridge railing 10 by the rotation of the roller part 200 as illustrated in FIG. 7, and the suicide jumper will fall to the inside of the bridge railing 10 by a lifting force of the roller part 200.

In particular, in a case of vertical pivoting of the roller part 200 as described above, when the pressure due to the weight of the suicide jumper is applied to the upper portion of the roller part 200, the vertical pivoting of the roller part 200 is performed by the pivoting obtained from the configuration of coupling the link part 100 and the leg part 400 through the elastic member 500. By the above-described configuration, when the weight direction of the suicide jumper applied to the roller part 200 is changed due to the one direction rotation of the roller part 200, the link part 100 and the leg part 400 are returned to their original positions form a bent state thereof through the elastic member 500, as illustrated in FIG. 7, and thereby the vertical pivoting of the roller part 200 occurs.

In addition, when one end of the link part 100 is coupled to the leg part 400, as illustrated in FIGS. 1 to 4 configured to firmly support the coupled link part 100, and control the pivoting of the link part 100, the leg part further includes a seat portion 430 formed therein.

As illustrated in FIG. 4, the seat portion 430 is configured so as to allow one side of the link part 100 coupled with the leg part 400 to be tightly coupled, and a pivoting angle of the pivoted link part 100 to be controlled, when the link part 100 is pivoted about the coupled leg part 400.

By the above-described configuration, even when the roller part 200 is operated to be vertically pivoted due to the weight of the suicide jumper, it is possible to prevent the link part 100 from being excessively lowered or raised from one side of the leg part 400. Thereby, it is possible to prevent the link part 100 and the leg part 400 from being damaged, and thus, prevent the jump suicide prevention device from being damaged.

Further, as illustrated in FIG. 4, the first insert groove 410 of the leg part 400 is provided with an insertion hole 421 into which the fastening member P to be fastened to the fixing hole 212 of the shaft rod 210 can be inserted. Therefore, by fastening the fastening member P from one side of the leg part 400, the elastic member 500, the link part 100, the rotation part 300, and the roller part 200 may be sequentially coupled to the one side of the leg part 400.

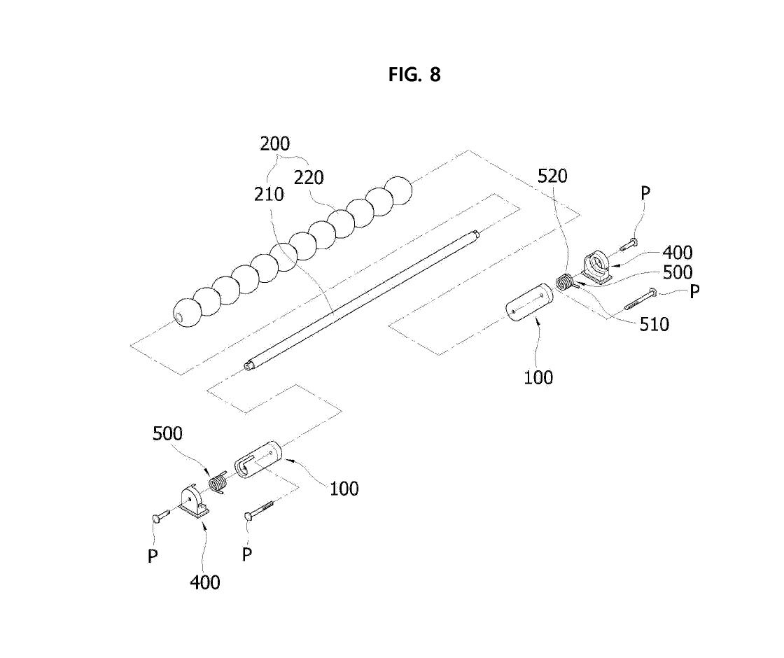

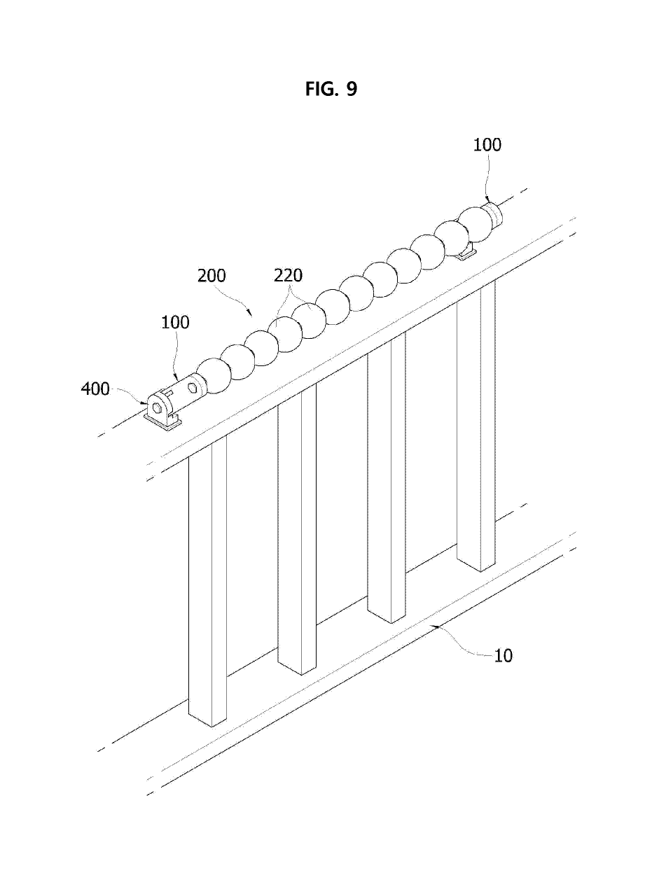

Further, as shown in FIGS. 8 and 9 that illustrate a configuration of roller bodies 220 connected to a shaft rod 210 inside a pair of link parts 100 according to another embodiment of the present invention, the roller body may be formed in a circular sphere shape having a through hole 220a into which the shaft rod 210 can be inserted, and a plurality of roller bodies may be connected with each other in the longitudinal direction of the shaft rod 210. Therefore, according to this embodiment of the present invention, it is also possible to prevent the suicide jumper from jumping over the upper portion of the roller body 220 by the rotation of the plurality of roller bodies 220 coupled to the shaft rod 210, without applying the configuration of the rotation part 300 to be coupled with the shaft rod 210.

However, the roller bodies 220 applied to another embodiment of the present invention as illustrated in FIG. 9 have a configuration that cannot maintain the one direction rotation, and the configuration of applying the roller bodies 220 may be appropriately changed and applied thereto according to a selection of the user.

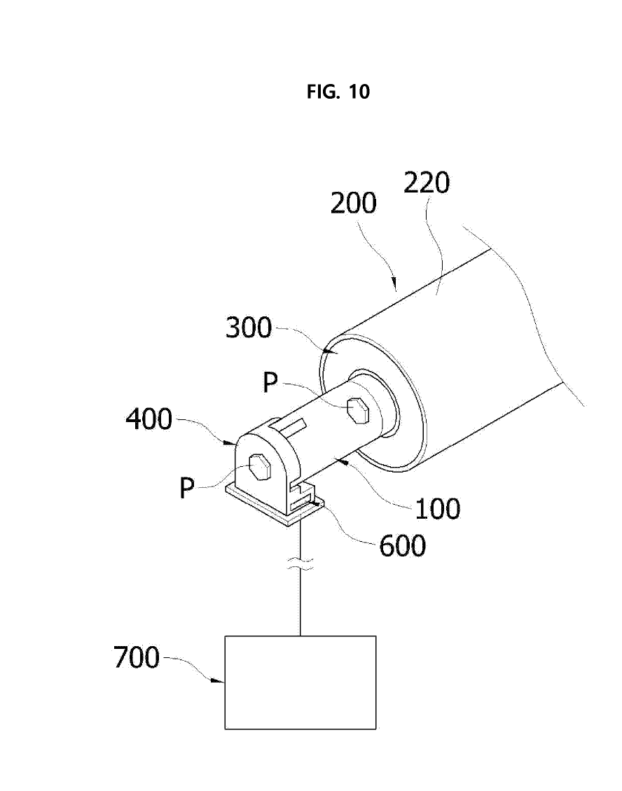

Meanwhile, as illustrated in FIG. 10, the leg part 400 may be configured in such a manner that a detection sensor 600 is provided on one side thereof, and the detection sensor 600 is connected with a central control unit 700 that receives a signal from the detection sensor 600 through a wire and controls the device.

The above-described configuration may be used to efficiently detect an installation position of the roller parts 200 which are installed according to the present invention, thus to efficiently detect the suicide jumper who tries to jump suicide. The detection sensor 600 may include and use a sensor that can detect a motion from a human body, or a sensor that can detect the position of the link part 100 to be coupled with the leg part 400.

Further, although not illustrated and described in detail in the present invention, as a configuration which receives a signal from the detection sensor 600 to perform a follow-up action according to the confirmed location of the suicide jumper, the controller 700 of the present invention may be configured to receive a signal from the detection sensor 600 and display the signal to an outside. Of course, the configuration may perform the same function as a control room capable of controlling such the control unit 700.

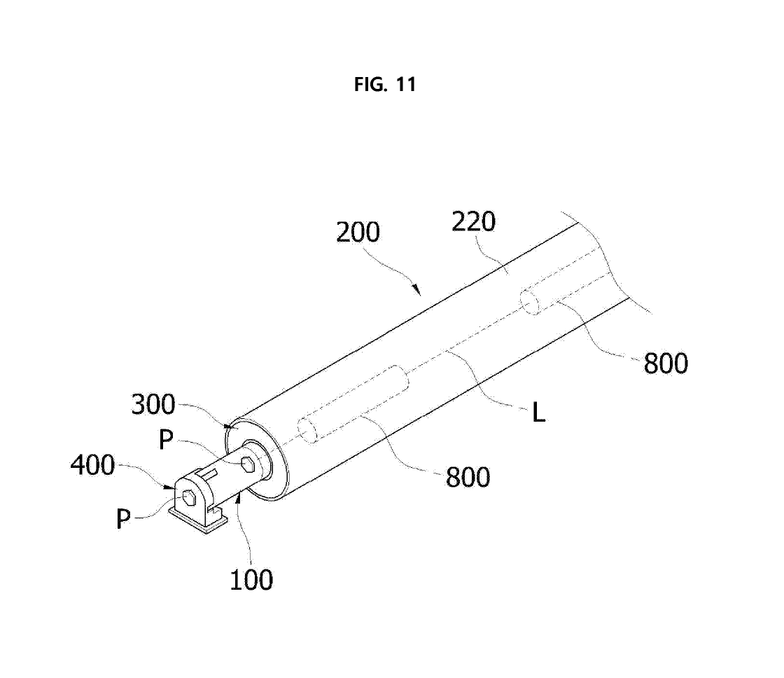

In addition, as illustrated in FIG. 11, the roller body 220 includes a plurality of lamps 800, which are illuminated by a power source supplied from an outside, provided inside the through hole 220a of the roller body 220, the roller body 220 may be made of a material that allows light of the lamps 800 to be transmitted therethrough.

The above-described configuration is used for improving an entire aesthetic sense of the bridge railing 10 on which the jump suicide prevention device of the present invention is installed through the illumination of the lamps 800, while preventing a deterioration in the aesthetic sense of the bridge due to a change in an appearance of the bridge even when the jump suicide prevention device of the present invention is installed on the bridge railing 10.

In the above description, although the jump suicide prevention device of the present invention is described so as to be applied to and used for the bridge railing 10, but it is not particularly limited thereto, and the device may be applied to a built structure having a distance from the ground, such as a veranda of apartments, a flat roof, or buildings, so as to prevent safety accidents of children and elderly people, and prevent the incidents of jump suicides from the apartments, buildings, or the like

While the present invention has been illustrated and described with reference to the specific embodiments, it will be understood by those skilled in the related art that various modifications and variations may be made therein without departing from the scope or gist of the present invention as defined by the appended claims.

### INDUSTRIAL APPLICABILITY

According to the present invention, in order to effectively prevent an occurrence of the incidents of jump suicides using the bridge railings by physically preventing the suicide jumper from jumping over the upper portion of the bridge railings installed on the bridge by means of the link parts installed on the bridge railings, and roller parts installed to be vertically pivoted at upper portions of the link parts and leg parts, when installing the jump suicide prevention device for bridge railings on the bridge railing, it is anticipated that the social loss due to the activation of the facility investment industry and the suppression of the jump suicide may be reduced.

1. A jump suicide prevention device for bridge railings, comprising:
a pair of link parts disposed to face each other on a bridge railing 10 in a longitudinal direction thereof;
a roller part which includes rotation parts on opposite sides thereof in the longitudinal direction to be rotatably coupled between the link parts in one direction;
leg parts which are respectively coupled to lower ends of the link part by fastening members, and
elastic members which are installed between end portions of the link part and the leg part with being interposed therebetween to control vertical pivoting of the link part.

2. The jump suicide prevention device for bridge railings according to claim 1, wherein the link part comprises:
a coupling hole formed in a bar shape at one end thereof in the longitudinal direction; and
a fastening hole formed at the other end thereof facing the coupling hole in the longitudinal direction to allow the fastening member to be inserted.

3. The jump suicide prevention device for bridge railings according to claim 1, wherein the roller part comprises:
a shaft rod installed Go as to connect the link parts with each other, while the rotation parts are coupled to the opposite ends thereof; and
a roller body which is arranged to surround an outer circumference of the shaft rod, and is rotatably coupled to the shaft rod in one direction through the rotation part at an outside thereof.

4. The jump suicide prevention device for bridge railings according to claim 3, wherein the roller body is formed in a circular bar shape having a through hole into which the shaft rod is inserted.

5. The jump suicide prevention device for bridge railings according to claim 4, wherein the rotation part is configured to be coupled inside the through hole of the roller body.

6. The jump suicide prevention device for bridge railings according to claim 3, wherein the roller body is formed in a circular sphere shape having a through hole into which the shaft rod is inserted, and a plurality of roller bodies are connected with each other in the longitudinal direction of the shaft rod.

7. The jump suicide prevention device for bridge railings according to claim 3, wherein the rotation part comprises:
a fixed body which is fixed to the outer circumference of the shaft rod; and
a rotating body coupled to surround an outer circumference of the fixed body,
wherein a latch portion and needle rollers are provided at a coupled portion between the fixed body and the rotating body, which are configured to allow the rotating body to rotate in one direction about the fixed body.

8. The jump suicide prevention device for bridge railings according to claim 7, wherein the shaft rod comprises a protrusion formed on one side of the outer circumference thereof, and a fixing hole to which one end of the fastening member passing through the leg part and the link part is fastened and fixed; and
the fixed body comprises a fitting groove to which the protrusion is fitted, and a through hole through which the fastening member passes to be coupled thereto.

9. The jump suicide prevention device for bridge railings according to claim 8, wherein the shaft rod comprises an insertion portion protruding in a circular protrusion shape at opposite ends in the longitudinal direction thereof, and
the fixed body comprises an insertion groove formed at one side of the through hole to allow the insertion portion be inserted therein.

10. The jump suicide prevention device for bridge railings according to claim 1, wherein the elastic member includes a spring having a first seat terminal and a second seat terminal which are formed in a bar shape at opposite ends thereof in the longitudinal direction.

11. The jump suicide prevention device for bridge railings according to claim 9, wherein the link part comprises:
a first seat groove formed at a portion thereof to be seated at and coupled to one side of the elastic member; and
a second seat groove that elongates from one side of the first seat groove to be engaged with the first seat terminal provided at one end of the elastic member.

12. The jump suicide prevention device for bridge railings according to claim 9, wherein the leg part comprises a first insert groove formed at a portion thereof to be seated at and coupled to the other side of the elastic member coupled to the link part, and a second insert groove that elongates from one side of the first insert groove to be engaged with the second seat terminal provided at the other end of the elastic member.

13. The jump suicide prevention device for bridge railings according to claim 12, wherein the leg part further comprises a seat portion formed therein configured to firmly support the coupled link part when one side of the link part is coupled therewith, and control the pivoting of the link part.

14. The jump suicide prevention device for bridge railings according to claim 12, wherein the first insert groove is provided with an insertion hole into which the fastening member to be fastened to the fixing hole of the shaft rod is inserted.

15. The jump suicide prevention device for bridge railings according to claim 1, wherein the roller part is formed to have a thickness enough to prevent a suicide jumper who tries to jump suicide by jumping over the bridge railings from gripping the same.

16. The jump suicide prevention device for bridge railings according to claim 1, wherein the roller part rotates only in an inner direction of the bridges to be installed.

17. The jump suicide prevention device for bridge railings according to claim 1, wherein the link part and the leg part installed on the bridge railing are arranged at an interval to prevent a suicide jumper who tries to jump suicide by jumping over the bridge railings from gripping outsides of the link part and the leg part by hands.

18. The jump suicide prevention device for bridge railings according to claim 1, wherein the leg part further comprises a detection sensor provided on one side thereof; and
the detection sensor is connected with a central control unit that receives a signal from the detection sensor through a wire and controls the device.

19. The jump suicide prevention device for bridge railings according to claim 4, wherein the roller body includes a plurality of lamps, which are illuminated through a power source supplied from an outside, provided inside the through hole thereof, and
the roller body is made of a material that allows light of the lamps to be transmitted therethrough.
